(19) United States
(12) Patent Application Publication
(10) Pub. No.: US 2018/0209117 A1
(43) Pub. Date: Jul. 26, 2018

(54) A ROTARY ACTUATOR FOR AN EXCAVATOR, A METHOD FOR TILTING AN EXCAVATOR TOOL AND USE OF A ROTARY ACTUATOR

(71) Applicant: Tiltman APS, Odder (DK)

(72) Inventor: Torben Kruse ULRIKSEN, Odder (DK)

(21) Appl. No.: 15/745,598

(22) PCT Filed: Jul. 14, 2016
(86) PCT No.: PCT/DK2016/050252

§ 371 Date: Jan. 17, 2018

(30) Foreign Application Priority Data
Aug. 24, 2015 (DK) PA201500496

(51) Int. Cl. E02F 3/36; E02F 9/22; F15B 15/06

(52) U.S. Cl. CPC E02F 3/3681; E02F 3/325; F15B 15/068; E02F 9/2271

(57) ABSTRACT

The invention relates to a rotary actuator (1) to be installed between a dipper arm (9) and an excavator tool (12) of an excavator (2). The rotary actuator (1) comprises a first actuator part (20) adapted to be fixed to the dipper arm (9) or to the excavator tool (12), wherein the first actuator part (20) is formed with an inner cylindrical orifice (23) comprising first part guide means (24). The rotary actuator (1) further comprises a second actuator part (21) adapted to be fixed to the other of the dipper arm (9) or the excavator tool (12), wherein at least a part of the second actuator part (21) is arranged inside the inner cylindrical orifice (23) and wherein the second actuator part (21) is rotatably supported by the first actuator part (20) while being substantially axially fixed in relation to the first actuator part (20). Furthermore, an outer cylindrical surface (25) of the second actuator part (21) comprises second part guide means (26). The rotary actuator (1) also comprises a piston part (22) arranged inside the inner cylindrical orifice (23) and around at least a part of the a second actuator part (21), wherein the piston part (22) is axially displaceable in relation to the a first actuator part (20) and the a second actuator part (21) and wherein an outer cylindrical piston part surface (29) is provided with outer piston part guide means (35) arranged to mesh with the first part guide means (24) and an inner cylindrical piston part surface (30) is provided with inner piston part guide means (36) arranged to mesh with the second part guide means (26). The second actuator part (21) is formed as a cantilever and piston means (27) of the piston part (22) extends all the way across the free end (28) of the second actuator part (21). The invention further relates to a method for tilting an excavator tool (12) in relation to a dipper arm (9) of an excavator (2) by means of a rotary actuator (1) and use of a rotary actuator (1).

### BACKGROUND OF THE INVENTION

The invention relates to a rotary actuator to be installed between a dipper arm and an excavator tool of an excavator, a method for tilting an excavator tool in relation to a dipper arm of an excavator by means of a rotary actuator and use of a rotary actuator.

### Description of the Related Art

Excavators known in the art typically comprise a boom unit including one or more arm members connected through joints, which enables that a excavator tool located at the end of the boom unit can be moved to or from the excavator cab, up and down and that the excavator tool may be moved back and forth independently from the arm members e.g. to perform a digging motion of the excavator tool.

However traditionally it is not possible to tilt the excavator tool laterally in relation to the boom unit. E.g. when digging along the foundation of a house or when digging a vertically ditch across sloping ground it would be advantageous if the excavator bucket could be tilted laterally e.g. to make it parallel with a vertical plane no matter if the entire excavator is tilted or to dig a narrow ditch parallel with a house foundation even though it is not possible to establish the boom unit parallel with the foundation.

From the international patent application No. 2005/026454 A1 it is known to provide a traditional large excavator with linear actuators positioned between the excavator bucket and the dipper arm of the boom unit. However the linear actuators are so space consuming that it would very difficult to fit this solution on a so-called compact excavator. Even if this device was scaled to fit a compact excavator its efficiency in relation to its weight and size would be poor and it would be so wide that part of the device would stick out over the sides of e.g. even a relatively wide excavator bucket, making it impossible to dig a narrow ditch with this linear actuator device mounted and/or it would be so high that it would not be able to pass under the outer joint of the boom unit or it would elongate the outer arm so much that the bucket capacity would be severely reduced.

From the European patent EP 1 238 166 B1 it is therefore known to arrange a rotary actuator between a dipper arm and an excavator tool of an excavator. However this solution is not very efficient compared to its size.

An object of the invention is therefore to provide for an advantageous technique for laterally tilting the excavator tool of an excavator, which does not present the above-mentioned drawbacks. Particularly it is an object to provide for a rotary actuator, which is size-efficient enough to be used even in relation with compact excavators.

### THE INVENTION

The invention provides for a rotary actuator to be installed between a dipper arm and an excavator tool of an excavator. The rotary actuator comprises a first actuator part adapted to be fixed to the dipper arm or to the excavator tool, wherein the first actuator part is formed with an inner cylindrical orifice comprising first part guide means. The rotary actuator further comprises a second actuator part adapted to be fixed to the other of the dipper arm or the excavator tool, wherein at least a part of the second actuator part is arranged inside the inner cylindrical orifice and wherein the second actuator part is rotatably supported by the first actuator part while being substantially axially fixed in relation to the first actuator part. Furthermore, an outer cylindrical surface of the second actuator part comprises second part guide means. The rotary actuator also comprises a piston part arranged inside the inner cylindrical orifice and around at least a part of the a second actuator part, wherein the piston part is axially displaceable in relation to the a first actuator part and the a second actuator part and wherein an outer cylindrical piston part surface is provided with outer piston part guide means arranged to mesh with the first part guide means and an inner cylindrical piston part surface is provided with inner piston part guide means arranged to mesh with the second part guide means. The second actuator part is formed as a cantilever and piston means of the piston part extends all the way across the free end of the second actuator part.

Forming the second actuator part as a cantilever is advantageous in that this enables that the piston means may span substantially the entire cross section of the inner cylindrical orifice to enable that hydraulic pressure may push over a great area to make the rotary actuator both compact and strong.

In an aspect of the invention, one of the outer piston part guide means and the first part guide means and one of the inner piston part guide means and the second part guide means are formed as a helical track.

Forming some of the guide means as helical tracks is advantageous in that it enables a smooth tilt motion while enabling full control of the meshing guide means since a track will provide guidance in both lateral directions.

In an aspect of the invention, the helical track has a pitch of between 50 and 1,000 mm, preferably between 100 and 600 mm and most preferred between 200 and 400 mm.

If the pitch is too big the stroke of the piston part will have to be increased to achieve the same tilt angle—which will increase the size of the rotary actuator. However, if the pitch is too little the shear force in the guide means will increase and the efficiency will therefore be reduced. The present pitch ranges therefore presents an advantageous relationship between efficiency and size.

In an aspect of the invention, the other of the outer piston part guide means and the first part guide means and the other of the inner piston part guide means and the second part guide means are formed as a guide protrusion.

In an aspect of the invention, the guide protrusion is formed as a guide pin or a guide fin.

Forming the guide protrusion as a guide pin is advantageous in that it simplifies manufacturing and assembly. However, forming the guide protrusion as a guide fin is advantageous in that it enables the force may be transferred over a larger area.

In an aspect of the invention, the piston means extends across the entire cross section of the inner cylindrical orifice.

Forming the piston means so that they fill out the entire cross section of the inner cylindrical orifice is advantageous in that the space-efficiency of the actuator hereby is increased.

In an aspect of the invention, the first actuator part comprises a housing part and an intermediate part, wherein the first part guide means are arranged on the intermediate part and wherein the housing part and the intermediate part are rigidly connected.

It can be very difficult to arrange guide means on or in the surface of the inner cylindrical orifice and it is therefore advantageous to form the first actuator part from two separate parts so that the guide means may be formed in the intermediate part which then subsequently can be placed in the inner cylindrical orifice. Furthermore, since the intermediate part is rigidly connected to the housing part this design also enables that the intermediate part aid in axially fixating the second actuator part while also enabling that the second actuator part may rotate in relation to the first actuator part.

In an aspect of the invention, the effective area of said piston part is substantially equal in both directions.

Forming the effective area substantially equal on both sides of the piston part is advantageous in that the rotary actuator hereby will be substantially equally strong no matter which side it tilts towards.

The invention further provides for a method for tilting an excavator tool in relation to a dipper arm of an excavator by means of a rotary actuator according to any of previously mentioned rotary actuators mounted between the excavator tool and dipper arm of the excavator.

Even further the invention relates to use of a rotary actuator according to any of the above-described rotary actuators for tilting the excavator tool of an excavator, wherein the excavator is a compact excavator with a total weight of up to 1500 kilograms.

Compact excavator—also known as mini excavators—are characterized by their low weight and small size making them ideal for use in domestic gardens, small spaces and so on. But this small size and weight naturally entails that the compact excavator is not as strong as a conventional excavator. The compact design and small weight of the present tilt device is therefore ideal for use on compact excavator with a total weight of up to 1500 kilograms and furthermore, it is actually possible to fit the present rotary actuator on such a compact excavator.

### FIGURES

The invention will be described in the following with reference to the figures in which

FIG. 1 illustrates a compact excavator as known in the art comprising a rotary actuator according to the invention, as seen in perspective,

FIG. 2 illustrates an exploded view of a rotary actuator, as seen from the top,

FIG. 3 illustrates a cross section through an exploded view of a rotary actuator, as seen from the top,

FIG. 4 illustrates an exploded view of a rotary actuator, as seen in perspective,

FIGS. 5, 6 and 7 illustrates a rotary actuator tilted 50° in a first direction,

FIGS. 8, 9, and 10 illustrates a rotary actuator in a middle direction,

FIGS. 11, 12 and 13 illustrates a rotary actuator tilted 50° in a second direction, and

FIG. 14 illustrates a rotary actuator, as seen in perspective.

### DETAILED DESCRIPTION

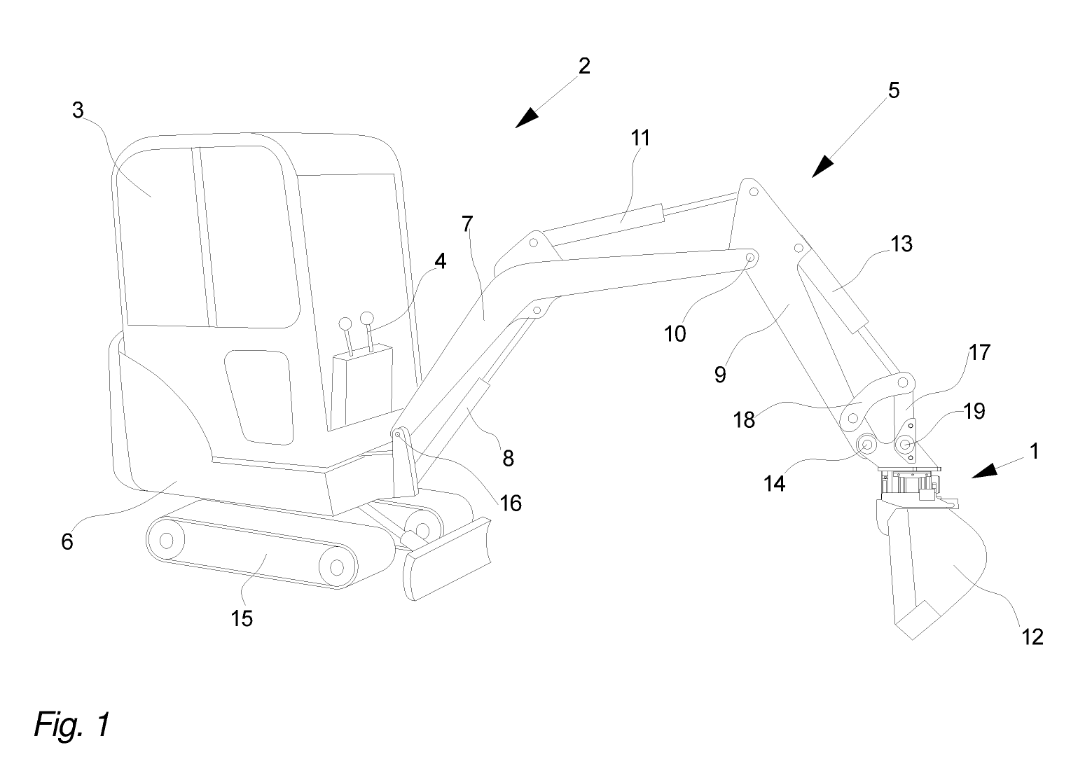

FIG. 1 illustrates an excavator 2 provided with a rotary actuator 1 according to the invention, as seen in perspective.

In this embodiment the excavator 2 is of the compact type also called a mini excavator but in another embodiment the excavator 2 could be of normal size where the term excavator 2 would include backhoes and conventional diggers.

An excavator 2 typically comprises some kind of load carrying frame 6 provided with a cab 3 comprising a driver's seat and e.g. a steering wheel or handles 4 for controlling the excavator 2 when driving it and when using it for excavating or the like.

The load carrying frame 6 is placed on a propulsion device 15 engaging the underlying ground. The propulsion device 15 enables that the entire excavator 2 can be moved around on its own.

At the front end of the frame 6 the excavator 2 is provided with a boom unit 5 also called a dipper stick. The boom unit 5 can usually be rotated in a vertical plane around a base joint 16 having a substantially horizontal axis of rotation and in another embodiment it could also be pivotally connected to the frame 6 through a joint comprising a substantially vertically axis of rotation but in this embodiment the boom unit 5 is fixed against lateral rotation.

In this embodiment the load carrying frame 6 including the boom unit 5 will have to be rotated in relation the propulsion device 15, if the lateral position of the boom unit 5 would have to be adjusted.

A typically boom unit 5 comprises a main boom 7 which can be rotated in a vertical plane by means of main boom actuator 8. The main boom 7 is connected to a dipper arm 9 through a middle joint 10 and the dipper arm 9 can be rotated in a vertical plane around the middle joint 10 by means of a dipper arm actuator 11.

The dipper arm 9 is provided with a tool actuator 13 for rotating the excavator tool 12 around a front joint 14 in a vertical plane. The tool actuator 13 acts on the excavator tool 12 through a tool arm 17 and a arm link 18 which enables that the linear motion of the tool actuator 13 is able to rotate the excavator tool 12 further in both directions than if the tool actuator 13 was connected directly to the excavator tool 12 through a pivot joint. This means that by way of the tool arm 17 and the arm link 18 the tool actuator 13 is capable of rotating the excavator tool 12 at least 180° whereas if the tool actuator 13 was coupled directly to the excavator tool 12 the tool actuator 13 would only be capable of rotating the excavator tool 12 approximately 140° and it would not be able to rotate the excavator tool 12 very far in the direction of the cab 3.

Typically the dipper arm 9 would then directly or through some sort of interconnection fitting be provided with an excavator tool 12 connected to the tool joint 19 and the front joint 14 but in this embodiment the boom unit 5 is provided with a rotary actuator 1 according to the invention between the dipper arm 9 and the excavator tool 12 making the tool actuator 13 rotate both the rotary actuator 1 and the excavator tool 12 around the front joint 14.

The rotary actuator 1 allows the excavator tool 12 to be tilted laterally in relation to the plane in which the main boom 7 and the dipper arm 9 rotates when they rotate around the base joint 16 and the middle joint 10, respectively.

In this embodiment the excavator tool 12 is a standard bucket but in another embodiment the tool 12 could be another passive tool such as a shovel, a leveling or planning device, a rake, a scoop or a blade. The excavator tool 12 could also be an active tool such as a jackhammer, a mechanical jaw or grip, a chain saw, a lawnmower or another type of electrically or hydraulically powered tool.

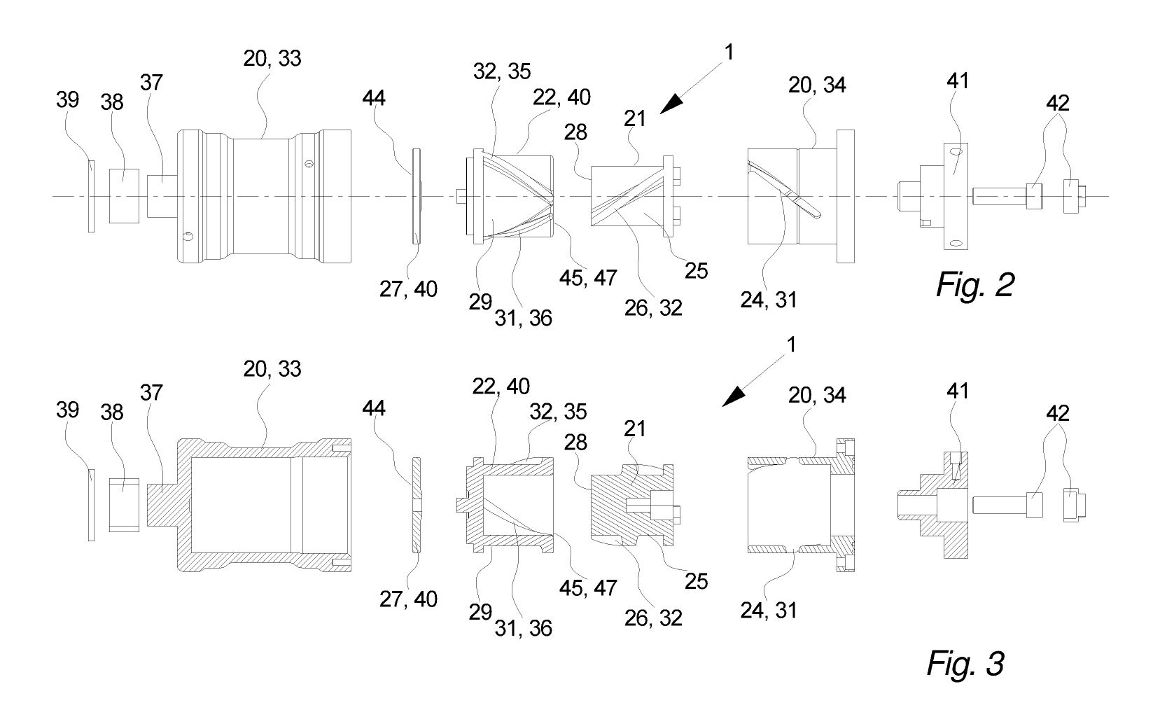

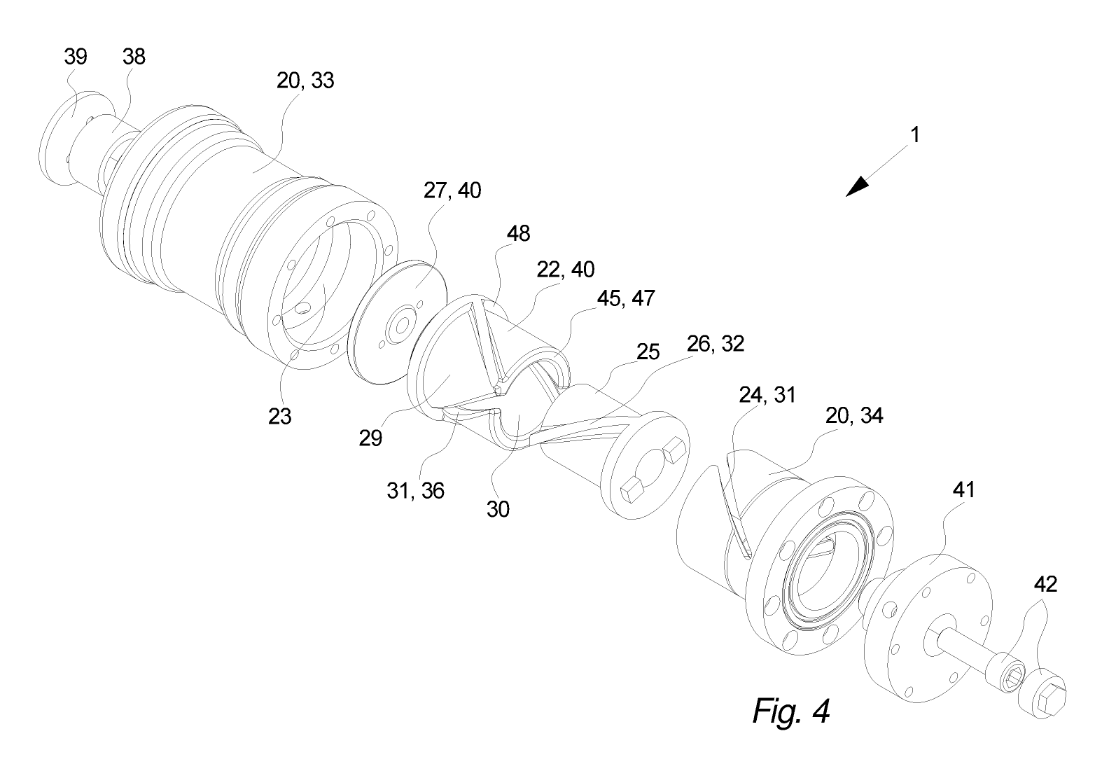

FIG. 2 illustrates an exploded view of a rotary actuator, as seen from the top, FIG. 3 illustrates a cross section through an exploded view of a rotary actuator, as seen from the top and FIG. 4 illustrates an exploded view of a rotary actuator, as seen in perspective.

In this embodiment the rotary actuator 1 from left to right comprises a housing part 33 comprising an end protrusion 37 enabling that a sleeve 38 can be mounted by means of and end disk 39 at this end of the rotary actuator 1 to enable rotary support.

Further, the rotary actuator 1 comprises piston means 27 and a piston housing 40 which together forms a piston part 22. In this embodiment the piston means 27 is a separate part which is to be rigidly fixed to the piston housing 40 but in another embodiment the piston means 27 and the piston housing 40 could be formed integrally.

Further on, the rotary actuator 1 comprises a substantially solid second actuator part 21 to be mounted inside an intermediate part 34 by means of an end cap 41 and connection means 42, so that when the connection means 42 joins the second actuator part 21 and the end cap 41, these parts 21, 41, 42 are axially fixed in relation to the intermediate part 34 but still able to rotate in relation to the intermediate part 34.

Most of the intermediate part 34 is arranged to be inserted in the housing part 33 and rigidly fixed to this so that intermediate part 34 and the housing part 33 together forms a first actuator part 20.

In this embodiment the first actuator part 20 is formed with helical tracks 31 and to arrange these inside the inner cylindrical orifice of the first actuator part 20 it is advantageous to arrange these in an intermediate part 34 and then rigidly connect the intermediate part 34 to the housing part 33. However, in another embodiment the intermediate part 34 and the housing part 33 would be formed integrally e.g. if the first actuator part 20 instead of helical tracks 31 was provided with guide protrusions 32 or other.

In this embodiment of the invention the piston part 22, the first actuator part 20 and the second actuator part 26 are provided with guide means 24, 26, 35, 36 of which an inner first actuator part surface 43 of the first actuator part 20 and an inner cylindrical piston part surface 30 of the piston part 22 are provided with helical track means 31 arranged to guide matching guide protrusions 32 in the form of elongated guide fins arranged on the outer cylindrical piston part surface 29 of the piston part 22 and the outer cylindrical surface 25 of the second actuator part 21, respectively. However, in another embodiment the guide protrusions 32 could be formed as guide pins, bearings, wheels, journal bearing or other and/or the matching and meshing guide means 24, 26, 35, 36 could be arranged differently.

In this embodiment the helical track 31 are formed as a cavity or a track machined into the respective surfaces 30, 43 but in another embodiment the helical track 31 could be formed as separate tracks, guides or similar connected to the respective parts 20, 22, 26.

In this embodiment the guide protrusions 32 are formed integrally with the respective surfaces 25, 29 but in another embodiment the guide protrusions 32 could be formed as separate fins, pins, bearings or similar connected to the respective parts 20, 22, 26.

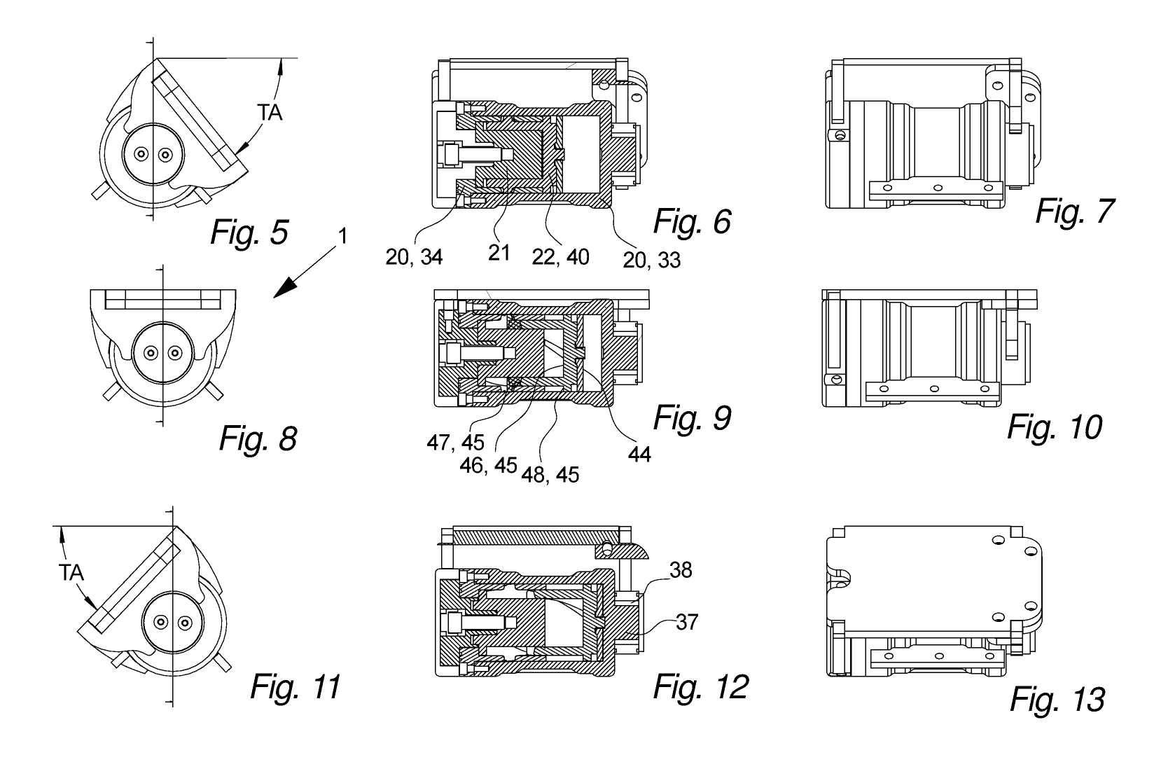

FIG. 5-7 illustrates a rotary actuator 1 tilted 50° in a first direction, FIG. 8-10 illustrates a rotary actuator in a middle direction and FIG. 11-13 illustrates a rotary actuator tilted 50° in a second direction, where FIGS. 5, 8 and 11 shows the rotary actuator 1 from the front, FIGS. 6, 9 and 12 shows a cross section down the middle of the rotary actuator 1 as seen from the side and FIGS. 7, 10 and 13 shows a rotary actuator 1 from the side.

In FIGS. 5-7 the rotary actuator is tilted all the way to a first extreme position which in this embodiment entails a tilt angle TA of 50°. In this extreme position hydraulic pressure on the front side 44 of the piston part 22 forces the piston part 22 all the way back against the second actuator part 21. To move tilt the rotary actuator 1 in the opposite direction hydraulic pressure is generated on the rear side 45 of the piston part 22 to force the piston part 22 away from the second actuator part 21 towards a middle position as illustrated in FIGS. 8-10 and finally to the other extreme position which in this embodiment entails a tilt angle TA of −50° where the piston part 22 is forced against the first actuator part 20.

When the piston part 22 moved from the position illustrated in FIGS. 5-7 to the position illustrated in FIGS. 11-13 the first part guide means 24 meshing with the outer piston part guide means 35 will entail that the piston part 22 is forced to rotate as it is displaced axially. An through the inner piston part guide means 36 meshing with the second part guide means 26 this rotation is increased towards the second actuator means as the piston part 22 is axially displaced. This double sided mesh of the piston part 22 will ensure a large tilt angle TA with a relatively short stroke of the piston part 22 thus ensuring a compact and efficient rotary actuator 1.

It is important to note that in this embodiment the efficient area—i.e. the total area over which the hydraulic pressure may act on the piston part 22—of the piston part 22 is substantially equal for the front side 44 of the piston part 22 and the rear side 45 of the piston part 22 in that when the piston part 22 moves axially from the position illustrated in FIG. 6 to the position illustrated in FIG. 12 the effective area of the piston part 22 includes the centre piston part surface 46, the rear piston part surface 47 and the peripheral piston part surface 48—the area of which together is equal to the area of the front side 44 of the piston part 22.

In this embodiment the diameter of the inner cylindrical orifice 23 and the outer diameter of the piston part is approximately 80 mm and the possible stroke of the piston part 22 is approximately 40 mm. However in another embodiment these and other sizes could be scaled up e.g. to fit a large excavator or scaled down e.g. to fit a very small excavator. Also ratio between diameters, stroke, pitch and other could be varied in numerous way e.g. to suit specific use, specific application, specific excavator tools 12 or other.

In another embodiment the helical tracks 31 could be formed with varying pitch e.g. to reduce tilt speed at the extreme positions.

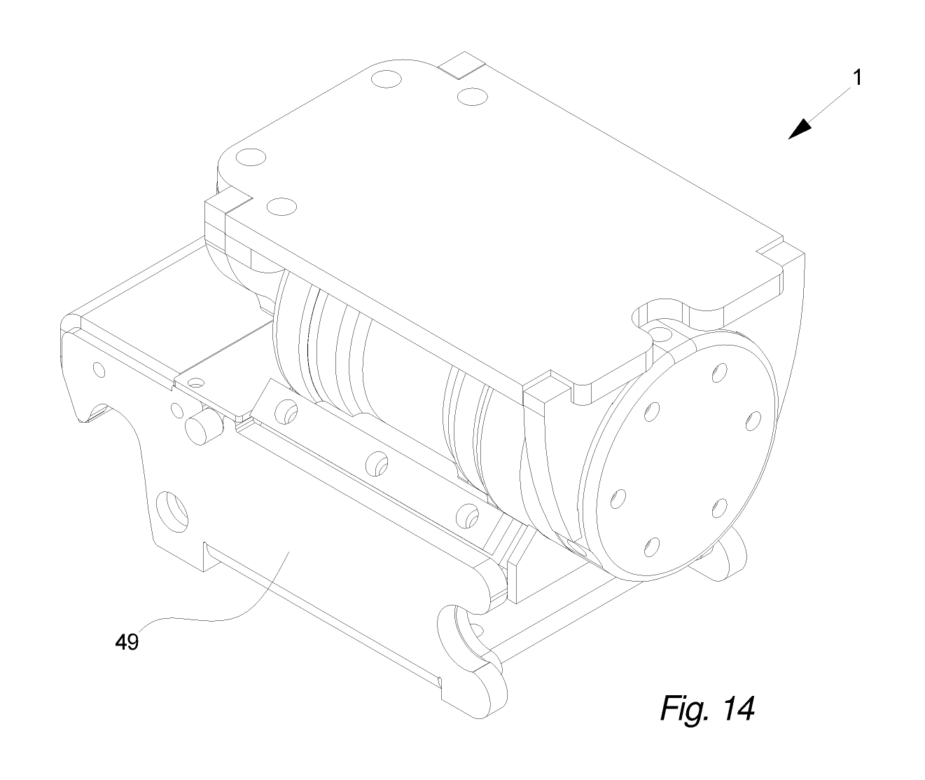

FIG. 14 illustrates a rotary actuator 1, as seen in perspective.

In this embodiment the first actuator part 20 of the rotary actuator 1 comprises a coupling device 49 enabling that if the second actuator part 21 is connected to the boom unit of an excavator 2 an excavator tool 12 can easily be mounted and dismounted from the rotary actuator 1 via the coupling device 49.

The invention has been exemplified above with reference to specific examples of rotary actuators 1, guide protrusion 32, guide means 24, 26, 35, 36 and other. However, it should be understood that the invention is not limited to the particular examples described above but may be designed and altered in a multitude of varieties within the scope of the invention as specified in the claims.

### LIST

1. Rotary actuator

2. Excavator

3. Cab

4. Handle

5. Boom unit

6. Load carrying frame

7. Main boom

8. Main boom actuator

9. Dipper arm

10. Middle joint

11. Dipper arm actuator

12. Excavator tool

13. Tool actuator

14. Front joint

15. Propulsion device

16. Base joint

17. Tool arm

18. Arm link

19. Tool joint

20. First actuator part

21. Second actuator part

22. Piston part

23. Inner cylindrical orifice

24. First part guide means

25. Outer cylindrical surface of the second actuator part

26. Second part guide means

27. Piston means

28. Free end of second actuator part

29. Outer cylindrical piston part surface

30. Inner cylindrical piston part surface

31. Helical track

32. Guide protrusion

33. Housing part

34. Intermediate part

35. Outer piston part guide means

36. Inner piston part guide means

37. End protrusion

38. Sleeve

39. End disc

40. Piston housing

41. End cap

42. Connection means

43. Inner first actuator part surface

44. Front side of piston part

45. Rear side of piston part

46. Centre piston part surface

47. Rear piston part surface

48. Peripheral piston part surface

49. Coupling device

TA. Tilt angle

1. A rotary actuator to be installed between a dipper arm and an excavator tool of an excavator, said rotary actuator comprising
a first actuator part adapted to be fixed to said dipper arm or to said excavator tool, wherein said first actuator part is formed with an inner cylindrical orifice comprising a first part guide,
a second actuator part adapted to be fixed to the other of said dipper arm or said excavator tool, wherein at least a part of said second actuator part is arranged inside said inner cylindrical orifice and wherein said second actuator part is rotatably supported by said first actuator part while being substantially axially fixed in relation to said first actuator part, wherein an outer cylindrical surface of said second actuator part comprises a second part guide, and
a piston part arranged inside said inner cylindrical orifice and around at least a part of said a second actuator part, wherein said piston part is axially displaceable in relation to said a first actuator part and said a second actuator part, wherein an outer cylindrical piston part surface is provided with an outer piston part guide arranged to mesh with said first part guide and an inner cylindrical piston part surface is provided with an inner piston part guide arranged to mesh with said second part guide,
wherein said second actuator part is formed as a cantilever and wherein a piston of said piston part extends all the way across the free end of said second actuator part.

2. A rotary actuator according to claim 1, wherein one of said outer piston part guide and said first part guide and one of said inner piston part guide and said second part guide are formed as a helical track.

3. A rotary actuator according to claim 2, wherein said helical track has a pitch of between 50 and 1,000 mm, preferably between 100 and 600 mm and most preferred between 200 and 400 mm.

4. A rotary actuator according to claim 2, wherein the other of said outer piston part guide and said first part guide and the other of said inner piston part guide and said second part guide are formed as a guide protrusion.

5. A rotary actuator according to claim 4, wherein said guide protrusion is formed as a guide pin or a guide fin.

6. A rotary actuator according to claim 1, wherein said piston extends across the entire cross section of said inner cylindrical orifice.

7. A rotary actuator according to claim 1, wherein said first actuator part comprises a housing part and an intermediate part, wherein said first part guide are arranged on said intermediate part and wherein said housing part and said intermediate part are rigidly connected.

8. A rotary actuator according to claim 1, wherein the effective area of said piston part is substantially equal in both directions.

9. A method for tilting an excavator tool in relation to a dipper arm of an excavator by means of a rotary actuator according to claim 1 mounted between said excavator tool and dipper arm of said excavator.

10. Use of a rotary actuator according to claim 1 for tilting the excavator tool of an excavator, wherein said excavator is a compact excavator with a total weight of up to 1500 kilograms.
